(19) United States
(12) Patent Application Publication
(10) Pub. No.: US 2026/0317595 A1
(43) Pub. Date: Oct. 15, 2026

(54) WATER SOLUBLE DEXTRIN ADHESIVES

(71) Applicant: Cargill, Incorporated, Wayzata, MN (US)

(72) Inventor: James Donald Steinke, Marion, IA (US)

(73) Assignee: Cargill, Incorporated, Wayzata, MN (US)

(21) Appl. No.: 19/482,286

(22) PCT Filed: May 16, 2024
(86) PCT No.: PCT/US2024/029575

§ 371 Date: Nov. 7, 2025

Related U.S. Application Data
(60) Provisional application No. 63/502,694, filed on May 17, 2023.

(51) Int. Cl. C09J 103/02; C09J 11/04; C09J 11/08

(52) U.S. Cl. CPC C09J 103/02; C09J 11/04; C09J 11/08

(57) ABSTRACT

Dextrin powders and one or more rheology modifiers are combined to form a powdered adhesive mixture. The powdered mixtures are dispersed in water to generate adhesive compositions. The dispersion of the powdered mixtures in water can be conducted under high shear conditions and/or low shear conditions. The adhesive compositions have a smooth texture and short structure. The adhesive compositions have the desired viscosity and a long shelf-life for use in a paper bag seam.

### CROSS-REFERENCE TO RELATED APPLICATIONS

This application claims the benefit of U.S. Provisional Application No. 63/502,694, filed May 17, 2023, which is incorporated by reference herein in its entirety.

### FIELD

The present invention relates to adhesive compositions and methods of generating adhesive compositions. The present invention also relates to powders for use in generating an adhesive composition.

### BACKGROUND

Starch is a polymeric carbohydrate consisting of numerous glucose units joined by α-(1→4)-D glycosidic bonds. This polysaccharide is produced by most green plants for energy storage. Worldwide, it is the most common carbohydrate in human diets, and is contained in large amounts in staple foods such as wheat, potatoes, maize (corn), rice, and cassava (manioc). Mixing most starches in warm water produces a paste which can be used as a thickening stiffening or glue agent. The non-food industrial use of starch is as an adhesive in the paper market making process.

Dextrins are a group of low-molecular-weight carbohydrates produced by the hydrolysis, transglycosylation and repolymerization of starch. Dextrins are the product of dry-roasting starch in the presence of an acid catalyst. Dextrins are mixtures of polymers of D-glucose units linked by α-(1→4) or α-(1→6) glycosidic bonds. Dextrins can be produced from starch using enzymes like amylases, or by applying dry heat under acidic conditions (pyrolysis or roasting). Dextrins produced by heat are also known as pyrodextrins. Dextrins are generally divided into 3 categories: white dextrins, yellow dextrins and British gums. The differences between the dextrins are attributed to the roasting time and temperature and the amount of catalyst used. Dextrins are partially or fully water-soluble.

Dextrins and modified dextrins have been used as adhesives for various applications. Paper bag seams are held together with water-based adhesives. Traditionally, adhesives are prepared from cook up starch, Borax and water and sold as liquid products. The solids levels in the liquid products is generally about 17 to 25% by weight and the remaining amount is water. To provide an adhesive composition to consumers, a liquid adhesive composition with water is shipped. Shipping liquid adhesives results in high shipping costs due to the water present in the liquid adhesive.

### SUMMARY

The present disclosure includes powders and powdered mixtures that can be dispersed in water under a variety of conditions to generate adhesive compositions. The powdered mixtures can be dispersed using mixers under high shear conditions and under low shear conditions. Advantageously, the adhesive compositions are stable regardless of the shear utilized to disperse the powders in the water. In addition, the adhesive compositions have a long shelf-life. Preferably the powdered mixtures are dispersed in water without the use of additional heat.

The present description advantageously provides a powdered mixture that can be dispersed in water by the consumer to generate an adhesive composition. This would result in lower shipping costs since only the powdered mixture would be shipped to the consumer. In other words, shipping costs for the water would be eliminated. The consumer can disperse the powdered mixture as needed. It is particularly advantageous that the powdered adhesive mixture in the present disclosure is dispersible using a wide array of mixing processes and mixing apparatus.

In one aspect, the present disclosure provides a method of generating an adhesive composition comprising dispersing a powder comprising dextrin powder and one or more rheology modifiers in water, wherein the temperature of the water is between 65° F. and 130° F., wherein the dextrin powder comprises a weight average molecular weight (Mw) between 30 kDa and 40 kDa, wherein the amount of resistant dextrins (RD) in the dextrin powder is at least 15 wt %, wherein the dextrin powder is derived from a starch with an amylose content of greater than 20% by weight. The method also includes mixing the dextrin powder, the one or more rheology modifiers and the water to generate an adhesive composition, wherein the mixing comprises low shear mixing and/or high shear mixing, wherein the adhesive composition comprises a solids content between 15% and 25% by weight of the adhesive composition, and wherein the adhesive composition comprises a short structure and smooth texture. The method may generate an adhesive composition wherein the Brookfield viscosity (BV) of the adhesive composition measured at 20 rpm at 25° C. is between 2000 cP and 3000 cP when the dextrin powder is dispersed at low shear. The method may generate an adhesive composition, wherein the BV of the adhesive composition measured at 100 rpm at 25° C. is between 700 cP and 1200 cP when dispersed at high shear. The low shear comprises between about 20 rpm and 70 rpm. The high shear comprises between about 1500 rpm and 3000 rpm. The adhesive composition generates a bond strength of at least 90 N with a paper bag seam. The adhesive composition generates a bond strength between 90 N and 130 N with a paper bag seam. The method may include generating an adhesive composition with a powdered premix that comprises the dextrin powder and the one or more rheology modifiers. The present description further includes an adhesive composition made by the method described above.

In another aspect, the present description includes a powdered adhesive mixture comprising dextrin powder and one or more rheology modifiers, wherein the dextrin powder comprises a Mw of between 30 kDa and 40 kDa, wherein the amount of RD in the dextrin powder is at least 15%, wherein the dextrin powder is derived from a starch with an amylose content of greater than 20%, and wherein the dextrin powder and the rheology modifiers are dispersible in water at low shear and high shear. The dextrin powder is derived from the dent corn. The dextrin powder comprises white/cream dextrins. The dextrin powder is derived from starches selected from the group consisting of corn, wheat, rice, sorghum, pea, sago and potato starch. The dextrin powder is between 95 wt % and 99.5 wt % of the powdered adhesive mixture. The rheology modifier is between 0.5 wt % and 5 wt % of the powdered adhesive mixture. The dextrin powder comprises a BV of between 500 cP and 2000 cP at 20 RPM. The dextrin powder comprises a BV of between 100 cP and 700 cP at 100 RPM. The particle size of the dextrin is between 2 microns and 30 microns. The particle size of the rheology modifier is between 1 micron and 350 microns. The mixture may further comprise an antifoaming agent. The mixture may further comprise a biocide. The mixture is dispersible in water at a temperature between 65° F. and 200° F. The rheology modifier comprises hydrocolloids, engineered clays and/or distarch phosphates. The rheology modifier is selected from the group consisting of guar, carrageenan, alginate, pectin and laponite. The mixture upon solubilization forms an adhesive composition with a smooth texture and short structure. The present description also includes an adhesive composition comprising the above powdered mixture.

In a further aspect, the present description includes an adhesive composition comprising dextrin powder and one or more rheology modifiers dispersed in water, wherein the dextrin powder comprises a Mw of between 30 kDa and 40 kDa, wherein the dextrin powder comprises RD of at least 15% by weight of the dextrin powder, wherein the dextrin powder is derived from a starch with an amylose content of greater than 20%, wherein the adhesive composition comprises a solids content between 15% and 25% by weight of the adhesive composition, or wherein the BV of the adhesive composition is between 2000 cP and 3000 cP when measured at 100 rpm at 25° C. The BV of the adhesive composition is between 700 cP and 1200 cP when measured at 100 rpm at 25° C. The BV of the adhesive composition is between 2000 cP and 3000 cP when measured at 20 rpm at 25° C. The dextrin powder has a solubility of between 60% and 85%. The adhesive composition comprises a smooth texture and a short structure. The adhesive composition generates a bond strength of greater than 90 Newtons on a paper bag seam. The adhesive composition is resistant to high shear and low shear. The low shear is between 20 rpm and 70 rpm. The high shear is between 1500 rpm and 3000 rpm. The shelf life of the adhesive composition is between 3 days and 8 days.

In yet a further aspect, the present description includes a method of adhering a seam of a paper bag comprising placing the adhesive composition of on a paper bag seam and allowing the adhesive composition to cure and generate a seam comprising a binding strength of at least 90 N. The adhesive composition is generated by the method described above.

In yet another aspect, the present description includes a powdered adhesive premix comprising dextrin powder and one or more rheology modifiers, wherein the dextrin powder comprises a Mw of between 30 kDa and 40 kDa, wherein the amount of RD in the dextrin powder is at least 15%, wherein the dextrin powder is derived from a starch with an amylose content of greater than 20%, and wherein the dextrin powder and the rheology modifiers are dispersible in water at low shear and high shear. The dextrin powder is derived from the dent corn. The dextrin powder comprises white/cream dextrins. The dextrin powder is derived from starches selected from the group consisting of corn, wheat, rice, sorghum, pea, sago and potato starch. The dextrin powder is between 95 wt % and 99.5 wt % of the powdered adhesive mixture. The rheology modifier is between 0.5 wt % and 5 wt % of the powdered adhesive mixture. The dextrin powder comprises a BV of between 500 cP and 2000 cP at 20 RPM. The dextrin powder comprises a BV of between 100 cP and 700 cP at 100 RPM. The particle size of the dextrin is between 2 microns and 30 microns. The particle size of the rheology modifier is between 1 micron and 350 microns. The mixture may further comprise an antifoaming agent. The mixture may further comprise a biocide. The mixture is dispersible in water at a temperature between 65° F. and 200° F. The rheology modifier comprises hydrocolloids, engineered clays and/or distarch phosphates. The rheology modifier is selected from the group consisting of guar, carrageenan, alginate, pectin and laponite. The mixture upon solubilization forms an adhesive composition with a smooth texture and short structure. The present description also includes an adhesive composition comprising the above powdered mixture.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

“Dextrins” or “dextrin powder” as used herein relates to a group of low-molecular weight carbohydrates produced by the hydrolysis, transglycosylation and repolymerization of starch. Dextrins are mixtures of polymers of D-glucose units linked by α-(1→4) or α-(1→6) glycosidic bonds. Dextrins include white dextrins, cream dextrins and yellow dextrins. “Dextrins” and “dextrin powder” will be used interchangeably.

“White dextrins” as used herein relates to dextrins produced at low temperatures (110 to 130° C.) and roasting times (3 to 7 hours) in the presence of a high concentration of catalyst. White dextrins can also include cream dextrins.

“Cream dextrins” as used herein relates to dextrins that are between white and yellow dextrins. Cream dextrins have less small hydrolytic fragments and more transglycosylation and repolymerization than white dextrins resulting in more color, higher solubility and more resistance. The viscosities of cream dextrins are lower than white dextrins and higher than yellow dextrins. The transglycosylation and repolymerization provide resistance to retrogradation and viscosity stability.

“Yellow dextrins” as used herein relates to dextrins prepared at high temperatures 135 to 160 degrees Celsius and longer roasting times 8 to 14 hours in the presence of less acid catalyst than are the white dextrins.

“Resistant dextrins” as used herein relates to dextrins that are not enzymatically hydrolyzed by α-amylase and amyloglucosidase. The resistant dextrins form bonds other than α-(1→4) or α-(1→6) glycosidic bonds. The percent resistant dextrin (% RD) are the amount of dextrins (by weight) that remain insoluble out of total amount of dextrins when enzymatically hydrolyzed.

“Rheology modifier” as used herein relates to a substance that alters the rheological properties of a material such as its viscosity, flowability and stability. Rheology modifiers can be organic or inorganic.

“Adhesive premix” and “powdered adhesive mixture” and “powdered mixture” as used herein relates to a powder comprising dextrins and one or more rheology modifiers as described herein. These terms will be used interchangeably in the present disclosure.

“Adhesive composition” as used herein relates to a liquid/paste adhesive comprising the powdered adhesive mixture dispersed in water. The powdered adhesive mixture is dispersible in water under high shear conditions and low shear conditions.

“Solids content of the adhesive composition” as used herein relates to the weight percentage of dextrins, the rheology modifiers, and any other powdered additives, e.g. biocide, antifoaming agents, added to the water to form the adhesive composition.

“Number average molecular weight” or “Mn” as used herein relates to the total weight of polymer divided by the total number of molecules.

“Weight average molecular weight” or “Mw” as used herein relates to the number of polymer chains of a given weight times the weight of material with that given molar mass divided by the total weight of polymer.

“Polydispersity index” or “PDI” as used herein relates to PDI-Mw/Mn. The PDI is an indication of how homogeneous the polymers are in size. If all polymers were the same chain length the PDI would be 1.0.

“Short structure” as used herein relates to capillary breakup technique wherein if the adhesive breaks between a thumb and forefinger quickly the structure is short and if the capillary can be drawn out longer, the structure is long.

“Smooth texture” as used herein relates to adhesive that is homogeneous and lack lumps or chunks by observation.

“Marshmallow” texture as used relates to a sticky texture similar to melted marshmallow and would not be an acceptable texture for the adhesive compositions described herein.

In one aspect, this disclosure relates to adhesive compositions. The adhesive compositions are generated from powdered mixtures comprising dextrins and one or more rheology modifiers. The powdered mixtures are dispersed in water to generate adhesive compositions. The dispersion of the powdered mixtures in water can be conducted under high shear conditions and low shear conditions to generate stable adhesive compositions.

The powdered adhesive mixtures of the present disclosure comprise dextrins. The dextrins are derived from starch. By derived, it is meant the type of starch that is the starting material and that, when hydrolyzed, transglycosylated and repolymerized to a level that results in the dextrins with the characteristics described herein. The starch can be from a variety of sources including, but not limited to corn, wheat, rice, sorghum, pea, sago, and sweet potatoes. Preferably, the dextrins are derived from cornstarch. Dextrins used in the present disclosure are derived from dent corn or waxy corn. Preferably, the dextrins are derived from dent corn starch. The dextrins can be white dextrins, cream dextrins, or yellow dextrins. The powdered mixtures may include yellow dextrins from dent corn. Preferably, the dextrins are white dextrins or cream dextrins. More preferably, the dextrins are white/cream dextrins derived from dent corn starch.

The powdered adhesive mixtures comprise dextrins derived from starches with higher amylose content than the amylose content in waxy corn. The dextrins can be derived from starches with lower amylopectin content than the amylopectin content in waxy corn. Preferably, the powdered adhesive mixtures comprise dextrins derived from starches wherein the amylose content in the starch is greater than 10% by weight, more preferably greater than 20% by weight, more preferably greater than 25% by weight. The powdered adhesive mixtures comprise dextrins derived from starches wherein the amylose content in the starch is between 20% by weight and 30% by weight, between 20% by weight and 25% by weight, preferably between 22% by weight and 28% by weight, more preferably between 21% by weight and 30% by weight, more preferably between 22% by weight and 30% by weight, more preferably between 23% by weight and 30% by weight, more preferably between 24% by weight and 30% by weight, more preferably between 25% by weight and 30% by weight, more preferably between 26% by weight and 30% by weight, more preferably between 27% by weight and 30% by weight, more preferably between 28% by weight and 30% by weight, more preferably between 29% by weight and 30% by weight.

Preferably, the powdered adhesive mixtures comprise dextrins derived from starches wherein the amylopectin content in the starch is less than 90% by weight, more preferably less than 80% by weight, more preferably less than 78% by weight. The powdered adhesive mixtures comprise dextrins derived from starches wherein the amylopectin content in the starch is between 60% by weight and 80% by weight, more preferably between 70% by weight and 80% by weight, more preferably between 70% by weight and 76% by weight.

The dextrin powders used in the adhesive compositions comprise the characteristics described herein. The characteristics of the adhesive compositions and methods of making the adhesive compositions can vary depending on the characteristics of the dextrins present. Thus, dextrins outside of the ranges described herein result in adhesive composition with different characteristics. The characteristics defining the dextrin powders herein comprise weight average molecular weight of the dextrins in the dextrin powders, number average molecular weight of the dextrins in the dextrin powders, the percent of the dextrins in the dextrin powder that are soluble in water, the percent of resistant dextrins (RD) in the dextrin powders that are not soluble in water, the polydispersity index of the dextrins in the dextrin powder, the degree of polymerization of the dextrins in the dextrin powder, the viscosity of the dextrins. The viscosity of the dextrins as disclosed herein relates to the viscosity of a solution with dextrins solubilized in water with a solids content of 45%. The viscosity of the dextrins provided is performed on a Brookfield viscometer (BV) with a RV model viscometer at 25° C. at 20 and 100 rpm and at a solids content of 25%.

The powdered adhesive mixture comprises dextrin powder. The dextrins in the powdered adhesive mixture comprise dextrins with a weight average molecular weight (Mw) between 20 kDa and 50 kDa, preferably between 20 kDa and 40 kDa, preferably between 30 kDa and 50 kDa, more preferably between 20 kDa and 30 kDa, more preferably between 40 kDa and 50 kDa, more preferably between 30 kDa and 40 kDa, more preferably between 32 kDa and 40 kDa, more preferably between 30 kDa and 38 kDa, more preferably between 30 kDa and 35 kDa, more preferably between 35 kDa and 40 kDa. Preferably, the powdered adhesive mixture does not include dextrin powders with Mw of greater than 50 kDa and/or less than 20 kDa.

The powdered adhesive mixture comprises dextrins with a number average molecular weight (Mn) between 2000 Da and 20,000 Da, preferably between 3000 Da and 18,000 Da, preferably between 4000 Da and 17,000 Da, more preferably between 5000 Da and 15,000 Da, more preferably between 5000 Da and 10,000 Da, more preferably between 10000 Da and 15,000 Da, more preferably between 8000 Da and 12,000 Da. Preferably, the powdered adhesive mixture does not include dextrin powders with Mn of greater than 20,000 Da or less than 2000 Da.

The powdered adhesive mixture comprises dextrins in a narrow range of Mw. The polydispersity index (PDI) relates to the distribution of sizes and is defined by Mw/Mn. The PDI of 1 relates to a uniform distribution of sizes. The PDI of the dextrins is equal to or less than 6, preferably between 2 and 6, more preferably between 2 and 5, more preferably between 3 and 6, more preferably between 3 and 5, and more preferably between 3.3 and 4.8. Preferably, the powdered adhesive mixture does not include dextrin powders with PDI of greater than 6 or more preferably greater than 7.

The degree of polymerization (DP) in the adhesive composition is defined as Mn/162. The DP can be between 20 and 100, preferably between 30 and 90, more preferably between 40 and 80 and more preferably between 41 and 72. Preferably, the powdered adhesive mixture does not include dextrin powders with DP of greater than 100 or less than 20.

The powdered adhesive mixture comprises dextrins with a range of particle sizes. The dextrin powder particle sizes comprise between one and 40 microns preferably between two and 30 microns, and more preferably between 5 and 20 microns, more preferably between 10 and 20 microns, more preferably between 10 and 15 microns, more preferably between 15 and 20 microns, more preferably between 12 and 18 microns. Preferably, the powdered adhesive mixture does not include dextrin powders with particle sizes of greater than 40 microns.

The solubility of a dextrin powder is determined by solubilizing known amount of dextrins in water. Methods for determining the solubility of dextrin powders are known in the art and are disclosed, for example, in Corn Refiners Associations, Dextrins, Solubles (D-56). The powdered mixtures comprise soluble dextrins between 55% by weight and about 85% by weight, preferably between 60% by weight and 85% by weight, more preferably between 60% by weight and 80% by weight, more preferably between 60% by weight and 75% by weight, more preferably between 60% by weight and 70% by weight, more preferably between 70% by weight and 85% by weight, more preferably between 70% by weight and 75% by weight, more preferably between 70% by weight and 80% by weight, more preferably between 75% by weight and 85% by weight, more preferably between 80% by weight and 85% by weight. The powdered mixture comprises dextrins preferably less than 85% by weight, more preferably not more than 85% by weight and not less than 55% by weight.

The resistant dextrin in a dextrin powder are determined by solubilizing known amount of dextrins in water. Methods for determining the resistant powders are known in the art and are disclosed in AOAC Official Method 996.11—Starch (Total) in Cereal Products. The powdered mixtures comprise resistant dextrin. The resistant dextrin are not solubilized during dispersal of the powdered mixture. The dextrin powder comprises between 10% and 30% by weight of resistant dextrin, preferably between 15% and 25% by weight of resistant dextrin, more preferably between about 15% and 20% by weight of resistant dextrin, more preferably between 20% and 25% by weight of resistant dextrin, more preferably between 15% and 18% by weight of resistant dextrin, more preferably between 22% and 25% by weight of resistant dextrin, more preferably between 18% and 22% by weight of resistant dextrin. Preferably, the dextrin powder does not comprise resistant dextrin at less than 15% by weight. Preferably, the dextrin does not comprise resistant dextrin at greater than 25% by weight.

The dextrin powders used in the powdered mixtures and/or to generate the adhesive compositions described herein comprise a range of viscosities. The viscosities of the dextrin powders are determined by solubilizing the dextrin powder in water. The viscosities of the dextrins disclosed herein are at a 25% solids content solubilized in water. It will be understood that the viscosity may vary as the solids content of the dextrin solutions varies. Preferably, the dextrin powders have a BV of between 100 centiPoise (cP) to 5000 cP at 20 rpm, more preferably between 500 cP to 2000 cP, more preferably 700 cP to 1900 cP, more preferably 1000 cP to 1900 cP, more preferably 1500 cP to 1900 cP, more preferably 700 cP to 1500 cP, more preferably 700 cP to 1000 cP. Preferably, the dextrin powders have a BV range of between 100 cP to 900 cP at 100 rpm, more preferably 100 cP to 625 cP, more preferably 125 cP to 625 cP, more preferably 125 cP to 500 cP, more preferably 125 cP to 300 cP, more preferably 300 cP to 625 cP, more preferably 450 cP to 625 cP.

The adhesive compositions described herein comprise powdered adhesive mixtures. The powdered adhesive mixtures comprise at least 90% by weight of dextrin. preferably the powdered adhesive mixtures comprise at least 95% by weight of dextrin, More preferably the powdered adhesive mixtures comprise at least 96% by weight of dextrin, more preferably the powdered adhesive mixtures comprise at least 97% by weight of dextrin, more preferably the powdered adhesive mixtures comprise at least 98% by weight of dextrin, more preferably the powdered adhesive mixtures comprise at least 99% by weight of dextrin, more preferably the powdered adhesive mixtures comprise at least 99.5% by weight of dextrin.

The powdered adhesive mixtures of the present disclosure comprise one or more rheology modifiers. A variety of rheology modifiers can be included in the powdered adhesive mixtures. Preferably, the powdered adhesive mixtures of the present disclosure comprise one rheology modifiers. Preferably, the powdered adhesive mixtures of the present disclosure comprise a combination of rheology modifiers. The rheology modifiers comprise hydrocolloids, engineered clays, and/or die starch phosphates. Preferably, the rheology modifiers comprise guar, carrageenan, alginate, pectin, and/or laponite. More preferably, the rheology modifiers comprise guar, more preferably the rheology modifiers comprise λ-carrageenan, more preferably the rheology modifiers comprise engineered clay.

The amount of rheology modifiers in the powdered adhesive mixtures can vary and can be at least 0.5% by weight of the powdered adhesive mixture, preferably between at least 0.5% by weight and 10% by weight. More preferably, the amount of rheology modifiers in the powdered adhesive mixture is between 0.75% by weight and 5% by weight, more preferably between 1% by weight and 5% by weight, more preferably between 2% by weight and 5% by weight, more preferably between 3% by weight and 5% by weight, more preferably between 0.75% by weight and 4% by weight.

The rheology modifiers advantageously hydrate quickly. The rheology modifiers preferably hydrate by at least 15 minutes, or by at least 30 minutes, or by at least 60 minutes, or by at least 2 hours, or by at least 3 hours, or by at least 5 hours. The rheology modifiers preferably hydrate between 15 min and 3 hours min, preferably between 30 minutes and 2 hours, more preferably between 30 minutes and 60 minutes.

The rheology modifiers are soluble in water at a temperature between about 20° C. and about 90° C., preferably between 20° C. and 80° C., more preferably 20° C. and 70° C., 20° C., more preferably between 20° C. and 60° C., more preferably between 20° C. and 50° C., more preferably between 20° C. and 40° C., more preferably between 20° C. and 30° C.

The rheology modifiers are preferably resistant to shear, preferably resistant to high shear, preferably dispersible at low shear, more preferably resistant to high shear and dispersible at low shear. Preferably, the rheology modifiers do not affect the structure of the adhesive composition. Preferably, the rheology modifiers do not affect the texture of the adhesive composition.

The powdered adhesive mixture comprises one or more rheology modifiers with a range of particle sizes. The rheology modifiers particle sizes comprise between one and 350 microns preferably between 10 and 320 microns, and more preferably between 20 and 200 microns, more preferably between 10 and 100 microns.

The powdered adhesive mixtures may comprise a variety of additives. Preferably, the one or more additives are powdered mixtures. The additives may be a liquid. The additives may be added when dispersing the powdered adhesive mixture. The additives may be added simultaneously or sequentially with the dextrins and the one or more rheology modifiers. The additives may be added to the adhesive composition after dispersal of the powdered composition. The one or more additives may comprise anti-foaming agents. A variety of anti-foaming agents may be used in are within the scope of this description. The anti-foaming agents comprise for example, MAGRABAR® MD-3500 by Münzing, XIAMETER™ ACP-1920 by DOW, and Foam Blast® PDR 21 by DyStar. If used, the anti-foaming agents can be used in an amount of between 100 ppm and 1000 ppm by weight of the adhesive composition, preferably between 150 ppm and 625 ppm.

The one or more additives may comprise biocides. A variety of biocides may be used, and all are within the scope of this description. The biocides comprise for example, sodium benzoate, calcium propionate, and potassium sorbate. If used, the biocides agents can be used in an amount between 50 ppm and 1000 ppm of the adhesive composition, preferably between 75 ppm and 500 ppm.

The powdered adhesive mixture preferably does not include non-natural ingredients. Preferably, the powdered adhesive mixtures do not include borax or borate. More preferably, the powdered adhesive mixtures are biodegradable.

The powdered adhesive mixture is preferably a cold-water soluble composition. When dextrins are added to cold water they preferably rapidly swell and disperse into water to form a smooth viscous paste. By cold-water soluble, it is meant that the powdered mixture is soluble in water between 65° F. and 80° F., more preferably between 65° F. and 75° F.

In one aspect, the present disclosure comprises a method of generating an adhesive composition. The adhesive composition comprises the powdered adhesive mixtures described herein. The powdered mixtures are generated by combining dextrin powder and one or more rheology modifiers. Preferably, the dextrin powder and the one or more rheology modifiers are dry blended. The adhesive compositions are generated by dispersing the powdered adhesive mixtures in water. Preferably, the powdered adhesive mixtures are dispersible when combined with water in a mixer at low shear and/or high shear. More preferably, the powdered adhesive mixtures are dispersible when combined with water in a mixer under low shear conditions, more preferably under high shear conditions, more preferably under low shear and high shear conditions. Preferably, the adhesive compositions generated using the powdered adhesive mixtures are dispersible without the addition of heat, for example at room temperature and are stable at room temperature. The adhesive composition preferably forms a paste after dispersal in water.

The method comprises dispersing the powdered adhesive mixtures in water at a temperature of at least 60° F. Preferably, the temperature of the water is at least 70° F., more preferably the temperature of the water is between 60° F. and 140° F., more preferably between 65° F. and 130° F., more preferably between 70° F. and 120° F., more preferably between 70° F. and 100° F., more preferably between 70° F. and 90° F., more preferably between 70° F. and 80° F., more preferably between 65° F. and 110° F., more preferably between 65° F. and 100° F. more preferably between 65° F. and 90° F., more preferably between 65° F. and 80° F.

The method comprises dispersing the powdered mixtures in a mixer. The powdered mixtures are dispersible in the water and form a stable adhesive composition regardless of the shear used by the mixer to disperse the powders. In other words, the powdered adhesive mixtures are dispersible in water when mixed with shear ranging from low shear to high shear. Preferably, the mixer comprises a low shear mixer, medium shear mixer and/or high shear mixer. Low shear mixers comprise, for example, ribbon blenders. High shear mixers comprise, for example, dissolvers. Advantageously, the powdered adhesive mixtures of the present disclosure are dispersible in low shear mixers and high shear mixers. Mixers that generate shear between low and high shear may also be used to disperse the powdered mixtures. Preferably, the powdered adhesive mixtures are dispersible in low shear mixers without formation of clumps or with negligible clump formation and are dispersible in high shear mixers while maintaining a short structure. Preferably, dispersal of the powdered mixtures in water generates an adhesive composition with a smooth texture and a short structure. The powdered adhesive mixtures are dispersible in water while generating a short structure to prevent slinging and a smooth texture.

The low shear mixer disperses the powdered mixture at a mixing rate of least 5 rpm, preferably at least at 20 rpm. The low shear mixing rate comprises a mixing rate between 5 rpm and 200 rpm, preferably a mixing rate between 20 rpm and 100 rpm, more preferably a mixing rate between 50 rpm and 100 rpm, more preferably a mixing rate between 20 rpm and 70 rpm, more preferably about 60 rpm. The dispersing may be performed at an ambient temperature of at least 60° F. Preferably, the ambient temperature is at least 65° F., more preferably the ambient temperature is at least 70° F., more preferably the ambient temperature is between 65° F. and 85° F. The mixing time with the low shear mixer comprises at least 10 minutes, preferably at least 20 minutes, preferably at least 45 minutes. The mixing time comprises less than 120 minutes, preferably less than 60 minutes. The mixing time comprises between 10 minutes and 80 minutes, preferably between 20 minutes and 60 minutes, more preferably between 30 minutes and 60 minutes, more preferably between 40 minutes and 60 minutes.

The high shear mixer disperses the powdered mixture with a mixing rate of least 900 rpm, preferably at least at 1200 rpm. The high shear mixing rate comprises a mixing rate between 1200 rpm and 3600 rpm, preferably a mixing rate between 1500 rpm and 3000 rpm, more preferably about 1700 rpm. The dispersing may be performed at an ambient temperature of at least 60° F. Preferably, the ambient temperature is at least 65° F., more preferably the ambient temperature is at least 70° F., more preferably the ambient temperature is between 65° F. and 85° F., more preferably between 65° F. and 80° F., more preferably between 65° F. and 75° F. The mixing time with the high shear mixer comprises at least 10 minutes, preferably at least 20 minutes, preferably at least 45 minutes. The mixing time comprises less than 120 minutes, preferably less than 60 minutes. The mixing time comprises between 10 minutes and 80 minutes, preferably between 20 minutes and 60 minutes, more preferably between 30 minutes and 60 minutes, more preferably between 40 minutes and 60 minutes.

In another aspect, the present disclosure comprises adhesive compositions generated by the dispersal of the powdered adhesive mixtures in water as described by the methods described herein. Preferably, the adhesive composition is a smooth paste texture with a short structure. The adhesive composition comprises at least 15% by weight of the powdered adhesive mixture. Preferably the adhesive composition comprises at least 17% by weight of the powdered adhesive mixture, more preferably between 17% and 27% by weight, more preferably between 18% and 25% by weight, more preferably between 20% and 25% by weight, more preferably between 22% and 25% by weight.

The viscosity of the adhesive composition generated by the dispersal of the powdered mixture may be measured. The viscosity values disclosed are Brookfield viscosity measurement performed with an RV model (medium viscosity) at 25° C. at either 20 rpm or 100 rpm.

Surprisingly, the BV viscosities of the adhesive composition were similar regardless of the shear used to disperse the powdered adhesive mixture. The adhesive compositions generated from dextrin powders described herein can be dispersed under high shear conditions or low shear conditions and results in the desired viscosity for an adhesive composition. In contrast, adhesive compositions generated from starch and dispersed under high shear mixing generally can have a high viscosity that is unacceptable for an adhesive composition.

The BV viscosity of the adhesive composition generated by dispersing the powdered adhesive mixture, at high shear or low shear, and measured at 20 rpm comprises at least about 1500 cP, more preferably between 2000 cP and 3000 cP, more preferably between 2000 cP and 2500 cP, more preferably between 2500 cP and 3000 cP, more preferably between 2200 cP and 2800 cP.

The BV viscosity of the adhesive composition generated by dispersing the powdered adhesive mixture, at high shear or low shear, and measured at 100 rpm comprises at least about 500 cP, preferably between 500 cP and 1500 cP, more preferably between 500 and 1000 cP, more preferably between 1000 and 1500 cP, more preferably between 700 and 1200 cP.

The adhesive compositions generated in the present description are stable and have a long shelf life. By stable, it is meant that the viscosity of the adhesive composition changes by less than 20%, preferably by less than 10%, more preferably by less than 5% over the indicated time period. The shelf-life of the adhesive compositions is stable at least 2 days, preferably at least 3 days, more preferably at least 5 days, more preferably at least 7 days. The shelf-life of the adhesive composition is stable between 2 days and 8 days, preferably between 3 days and 7 days, more preferably between 4 days and 6 days, more preferably between 4 days and 7 days, more preferably between 4 days and 8 days, more preferably between 5 days and 7 days.

In one aspect, the adhesive compositions are applied to the seam(s) of a paper bag and affixed. The strength of the bond of the seam of the paper bag can be evaluated to determine the adhesive strength. Methods to determine the strength of the seam are known in the art and are disclosed for example, in ASTM D1002, ASTM D3163, and ASTM D5868. The adhesive compositions described herein generate a bond strength of greater than 80 Newtons (N) when used on a paper bag seam. Preferably, the adhesive compositions generate a bond strength of greater than 90N, more preferably greater than 95N, more preferably greater than 100N, more preferably greater than 110N, and more preferably greater than 120N. Preferably, the adhesive compositions generate bond strengths between 90N and 130N, more preferably between 90N and 120N, more preferably between 95N and 120N, more preferably between 90N and 110N, more preferably between 100N and 130N, more preferably between 100N and 120N, more preferably between 110N and 130N and more preferably between 120N and 130N.

The adhesive composition disclosed herein minimize the amount of penetration into the paper in the seam of the paper bag. The amount of adhesive composition that penetrates the seam is less than 1 micron, preferably less than two microns, preferably less than 5 microns. The adhesive composition substantially remains on the surface of the paper seam.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Measurement of Viscosity

Viscosities were measured using a Brookfield viscometer. A medium viscosity (RVDV) model was used. Viscosities were measured either at 20 rpm or 100 rpm. Viscosity includes a rotational viscometer that turned a spindle in a composition. The resistance of the spindle to turn is known as the viscous drag. The viscosity value displayed is dependent on the spindle geometry and speed of rotation. The shear rates are fixed and are dependent on the spindle geometry and viscometer model.

### Example 2—Measurement of Bond Strength

Bond strength was measured as described in ASTM #D1002, #D3163 and #D5868. An adhesive was applied to a defined surface area at a predetermined application rate, the substrates were overlapped and then clamped in a tester. The bonded area was typically pressed for a defined interval released and then the bond is pulled in opposite directions until the bond is separated or the substrate broke. The force needed to pull the substrate apart was then determined to be the bonding strength. The method was for evaluating paper bag adhesives on 50 pound unbleached Kraft paper.

The equipment and materials were as follows: (i) Automated Bonding Evaluation System (ABES) with AES-Test™ Control software, Adhesive Evaluation Systems. (ii) Drawdown applicator rod, wire-wound, #30, BYK-Gardner (iii) Kraft paper, 50 lb., unbleached. (iv) Transfer pipet and (v) Pulp Test Blotter, 8″×8″, Independent Paper Resource LLC.

Procedure: The 50 lb. Kraft paper was cut into 1.00″ by 4.25″ (25×108 mm) strips. A line is marked one inch from the end of a strip of paper. The paper strip was placed towards the center of a sheet of blotter paper. Using a transfer pipet, a small amount of adhesive was applied perpendicular across the strip, just inside the line on the strip of paper. The drawdown rod was placed on the opposite side of the adhesive, the rod was pressed down, and draw the rod through the adhesive towards the end of the paper strip. Be sure that the entire one-inch square area at the end of the paper strip is covered with adhesive. If not, repeat. See Note 1. A second strip of paper was immediately placed in the opposite direction on the top of the adhesive. The two strips were gently pressed together with fingers. The paper strips were immediately mounted in the ABES tester. The AES-Test™ Control software was started. After the test run has been completed, the bond force in Newtons (N) was recorded. The #30 drawdown rod was manufactured to apply a wet film of 30 mils or 76 μm thick. That film thickness leaves 0.010 to 0.016 g/in² of adhesive on a paper test strip, which equates to 15 to 25 GSM of adhesive. Average application rates on production-scale machines are about 22 GSM. The AES-Test™ Control software settings should be set to 15 seconds of press, two seconds of cooling, and four seconds of pull. Also, be sure that the heat to the platens is turned off.

### Example 3—Preparation of Adhesive Composition with High Shear Mixing

Dextrins were the Cargill DrySet 08501 cream, dent dextrin and can be purchased from Cargill, Inc. The rheology modifiers were dry blended into the dextrin powder at the listed dosages in Table 1. All the dry blends were dispersed in water at 25% solids by weight using a high shear mixer, e.g., at 1700 rpm. The typical lab-scale adhesive target weight was 400 grams. The appropriate amount of adhesive powder (dextrin powder and rheology modifier) was weighed out on a dry basis to achieve the desired solids target. The appropriate amount of hot tap water (115° F.±5° F.) was added into a 1200 milliliter, SS beaker. An overhead stirrer was placed and fitted with an anchor-style impeller into the beaker. The mixture was started and adjusted to about 60 rpm for a low shear method or to 1700 rpm for a high shear method. The dry adhesive powder was slowly added to the beaker over a 5 minute. The adhesive mixture was allowed to mix for an additional 60 minutes. The adhesive mixture was dosed with 2500 ppm isothiazolinone biocide and transferred to a container

Starch based adhesive mixture using Collabond and EMCOL were made as described above for Cargill DrySet 08501 with high shear mixing and the results are shown in Table 2.

Table 1 shows the results for a number of different adhesive composition with different rheology modifiers and amounts of rheology modifiers. All of the experiments shown in Table 1 used Cargill DrySet 08501 cream, dent dextrin at 25% solids. The powdered adhesive compositions were added to water and mixed using high shear.

Initial viscosity, viscosity stability and bond strength measurements were taken on the adhesive composition. The viscosities of the adhesive composition with the dispersed adhesive powders were measured on Brookfield viscometer at 20 rpm @25° C. The desired target range for the viscosity is between about 2000 cP and about 3000 cP.

Viscosity stability was measured over a 7-day period and calculated as shown in Eq. (1).

$$Visco . Stab . = \frac{T / 0 BV - 7 day BV}{T / 0 BV} \times 100 \% \qquad ( Eq . 1 )$$

### Results

Table 1 indicates the dosage of the rheology modifiers and the characteristics of the dextrin based adhesive compositions mixed at high shear. All the compositions had a smooth texture and had a short structure. Table 2 shows the results for starch based adhesive compositions mixed at high shear. The texture and structure varied for the starch-based compositions and are indicated in Table 2.

TABLE 1

| | | | | | VISCO. | BOND |
|---|---|---|---|---|---|---|
| | | | DOSE | T/0 BV | STAB. | STRENGTH |
| RHEO. MOD. | BRAND NAME | MANUF. | (%) | (cP) | (% loss/gain) | (Newtons) |
| Pectin | Unipectine 64017 | Cargill | 3.7 | 3750 | −4 | 97 |
| Pectin | Unipectine OF 800 | Cargill | 4.0 | 3200 | +6 | 106 |
| λ-Carrageenan | None | Modernist | 1.0 | 2620 | −9 | 100 |
| | | Pantry | | | | |
| Sodium | None | Modernist | 1.0 | 2710 | −3 | 92 |
| alginate | | Pantry | | | | |
| Pectin | Unipectine QC 100 | Cargill | 1.0 | 2920 | 0 | 102 |
| Sodium | Satialgine TMS 100 | Cargill | 0.5 | 2460 | −4 | 105 |
| alginate | | | | | | |
| Engineered | Laponite-RD | BYK | 4.0 | 3100 | +3 | 137 |
| clay | | | | | | |
| Guar gum | ECOPOL-2000 | Economy | 0.75 | 3500 | −6 | 112 |
| | | Polymers | | | | |
| Guar gum | ECOPOL-18 | Economy | 0.75 | 3310 | −19 | 120 |
| | | Polymers | | | | |
| Distarch | StabiTex 12620 | Cargill | 4.0 | 2830 | +8 | 120 |
| phosphate | | | | | | |
| Distarch | StabiTex 12620 | Cargill | 3.0 | 2210 | +4 | 120 |
| phosphate | | | | | | |

TABLE 2

| | | | | VISCO. | BOND | | |
|---|---|---|---|---|---|---|---|
| | | SOLIDS | T/0 BV | STAB. (% | STRENGTH | | |
| PRODUCT | MANUF. | (%) | (cP) | loss/gain) | (Newtons) | TEXTURE | STRUCTURE |
| Collabond | Agrana | 17 | 14,000 | −4 | 84 | Smooth | Medium |
| 8017 | | | | | | | |
| Collabond | Agrana | 25 | 8300 | −11 | 98 | Smooth | Medium |
| 8025 | | | | | | | |
| EMCOL | Emslund | 20 | 3300 | +11 | 91 | Marshmallow | Short |
| KMB 30 | | | | | | | |
| EMCOL | Emslund | 25 | 25,300 | +134 | 85 | Marshmallow | Short |
| KMB 30 | | | | | | | |
| EMCOL | Emslund | 20 | 7200 | +2 | 84 | Smooth | Medium |
| KP 40 | | | | | | | |
| EMCOL | Emslund | 25 | 30,200 | Gelled | Gelled | Gelled | Gelled |
| KP 40 | | | | | | | |

As can be seen in Table 2, none of the starch-based products had the smooth texture combined with a short structure. The dextrin-based products were within target BV range using high shear prep vs. the high BV values generated for all starch-based products except for KMB 30@20% solids. Visco stability was acceptable for all but KMB 30 at 25% solids and KP 40 at 25% solids. Bond values for all starch-based adhesives were inferior to all dextrin-based adhesives.

### Example 4—Preparation of Adhesive Composition with Low Shear Mixing

Dextrin based adhesive compositions were made as described above in Example 3 except the appropriate amount of adhesive powder (dextrin powder and rheology modifier) was dispersed in water under low shear and the results shown in Table 3.

Starch based adhesive were made as described above in Example 3 except the adhesive was prepared under low shear mixing conditions and the results shown in Table 4.

### Results

Table 3 indicates the dosage of the rheology modifiers and the characteristics of the dextrin based adhesive compositions mixed at low shear. All the compositions had a smooth texture and had a short structure.

TABLE 3

| | | | | | VISCO. | BOND |
|---|---|---|---|---|---|---|
| | | | DOSE | T/0 BV | STAB. (% | STRENGTH |
| RHEO. MOD. | BRAND NAME | MANUF. | (%) | (cP) | loss/gain) | (Newtons) |
| Pectin | Unipectine 64017 | Cargill | 2.5 | 3920 | +14 | 97 |
| Pectin | Unipectine OF 800 | Cargill | 3.0 | 2870 | +14 | 97 |
| Pectin | Unipectine QC | Cargill | 2.0 | 2920 | +9 | 93 |
| | 100 | | | | | |
| λ-Carrageenan | None | Modernist | 1.0 | 2572 | +1 | 92 |
| | | Pantry | | | | |
| Sodium alginate | None | Modernist | 1.0 | 2710 | +12 | 91 |
| | | Pantry | | | | |
| Engineered clay | Laponite-RD | BYK | 3.0 | 2260 | 0 | 108 |
| Guar gum | None | Modernist | 0.5 | 2810 | +8 | 93 |
| | | Pantry | | | | |

Table 4 shows the results for starch based adhesive compositions mixed at low shear. The texture and structure varied for the starch-based compositions and are indicated in Table 4.

TABLE 4

| | | | | VISCO. | BOND | | |
|---|---|---|---|---|---|---|---|
| | | SOLIDS | T/0 BV | STAB. (% | STRENGTH | | |
| PRODUCT | MANUF. | (%) | (cP) | loss/gain) | (Newtons) | TEXTURE | STRUCTURE |
| Collabond | Agrana | 17 | 3280 | +90 | 93 | Smooth | Medium |
| 8017 | | | | | | | |
| Collabond | Agrana | 25 | 2550 | −1 | 100 | Smooth | Short |
| 8025 | | | | | | | |
| EMCOL | Emslund | 20 | 3940 | 0 | 93 | Smooth | Short |
| KMB 30 | | | | | | | |
| EMCOL | Emslund | 25 | 5920 | +104 | 90 | Chunky | Medium |
| KMB 30 | | | | | | | |
| EMCOL | Emslund | 20 | 4040 | +27 | 92 | Smooth | Medium |
| KP 40 | | | | | | | |
| EMCOL | Emslund | 25 | 4970 | Gelled | Gelled | Gelled | Gelled |
| KP 40 | | | | | | | |

Collabond 8025 and EMCOL KMB 30 had a smooth texture and short structure when mixed at low shear. However, EMCOL KMB 30 had high viscosity. Collabond 8025 performed well when mixed at low shear but did not perform well when mixed at high shear. When mixed at high shear, Collabond 8025 had high viscosity and a medium structure. See Table 2.

The invention claimed is:

1. A method of generating an adhesive composition comprising:
dispersing a powder comprising dextrin powder and one or more rheology modifiers in water, wherein the temperature of the water is between 65° F. and 130° F., wherein the dextrin powder comprises a weight average molecular weight (Mw) between 30 kDa and 40 kDa, wherein the amount of resistant dextrin (RD) in the dextrin powder is at least 15 wt %, wherein the dextrin powder is derived from a starch with an amylose content of greater than 20% by weight; and
mixing the dextrin powder, the one or more rheology modifiers and the water to generate an adhesive composition, wherein the mixing comprises low shear mixing and/or high shear mixing,
wherein the adhesive composition comprises a solids content between 15% and 25% by weight of the adhesive composition, and wherein the adhesive composition comprises a short structure and smooth texture.

2. The method of generating an adhesive composition of claim 1, wherein the Brookfield viscosity (BV) of the adhesive composition measured at 20 rpm at 25° C. is between 2000 cP and 3000 cP when the dextrin powder is dispersed at low shear.

3. The method of generating an adhesive composition of claim 1, wherein the BV of the adhesive composition measured at 100 rpm at 25° C. is between 700 cP and 1200 cP when dispersed at high shear.

4. The method of generating an adhesive composition of claim 1, wherein the low shear mixing comprises between about 20 rpm and 70 rpm.

5. The method of generating an adhesive composition of claim 1, wherein the high shear mixing comprises between about 1500 rpm and 3000 rpm.

6. The method of generating an adhesive composition of claim 1, wherein the composition generates a bond strength of at least 90 N with a paper bag seam.

7. (canceled)

8. The method of generating an adhesive composition of claim 1, wherein a powdered premix comprises the dextrin powder and the one or more rheology modifiers.

9. (canceled)

10. A powdered adhesive mixture comprising:
dextrin powder and one or more rheology modifiers,
wherein the dextrin powder comprises a Mw of between 30 kDa and 40 kDa,
wherein the amount of RD in the dextrin powder is at least 15%,
wherein the dextrin powder is derived from a starch with an amylose content of greater than 20%,
and wherein the dextrin powder and the rheology modifiers are dispersible in water at low shear and high shear.

11. (canceled)

12. (canceled)

13. The mixture of claim 10, wherein the dextrin powder is derived from starches selected from the group consisting of corn, wheat, rice, sorghum, pea, sago and potato starch.

14. (canceled)

15. (canceled)

16. The mixture of claim 10, wherein the dextrin powder comprises a BV of between 500 cP and 2000 cP at 20 RPM.

17. The mixture of claim 10, wherein the dextrin powder comprises a BV of between 100 cP and 700 cP at 100 RPM.

18. (canceled)

19. (canceled)

20. (canceled)

21. (canceled)

22. The mixture of claim 10, wherein the mixture is dispersible in water at a temperature between 65° F. and 200° F.

23. The mixture of claim 10, wherein the rheology modifier comprises hydrocolloids, engineered clays and/or distarch phosphates.

24. The mixture of claim 10, wherein the rheology modifier is selected from the group consisting of guar, carrageenan, alginate, pectin and laponite.

25. The mixture of claim 10, wherein the mixture upon solubilization forms an adhesive composition with a smooth texture and short structure.

26. (canceled)

27. An adhesive composition comprising dextrin powder and one or more rheology modifiers dispersed in water, wherein the dextrin powder comprises a Mw of between 30 kDa and 40 kDa,
wherein the dextrin powder comprises RD of at least 15% by weight of the dextrin powder,
wherein the dextrin powder is derived from a starch with an amylose content of greater than 20%,
wherein the adhesive composition comprises a solids content between 15% and 25% by weight of the adhesive composition.

28. The adhesive composition of claim 27, wherein the BV of the adhesive composition is between 700 cP and 1200 cP when measured at 100 rpm at 25° C.

29. The adhesive composition of claim 27, wherein the BV of the adhesive composition is between 2000 cP and 3000 cP when measured at 20 rpm at 25° C.

30. The adhesive composition of claim 27, wherein the dextrin powder has a solubility of between 60% and 85%.

31. The adhesive composition of claim 27, wherein the composition comprises a smooth texture and a short structure.

32. (canceled)

33. (canceled)

34. (canceled)

35. (canceled)

36. (canceled)

37. (canceled)

38. (canceled)

39. (canceled)
